(19) United States
(12) Patent Application Publication
(10) Pub. No.: US 2026/0275097 A1
(43) Pub. Date: Sep. 17, 2026

(54) THERMOPLASTIC MOLDING COMPOSITION COMPRISING SPENT COFFEE GROUNDS

(71) Applicant: INEOS STYROLUTION GROUP GMBH, Frankfurt am Main (DE)

(72) Inventors: Jarrett R. ROWLETT, Oswego, IL (US); Thomas W. Cochran, Wilmington, IL (US)

(21) Appl. No.: 19/166,925

(22) PCT Filed: Mar. 18, 2024
(86) PCT No.: PCT/EP2024/057109

§ 371 Date: Sep. 19, 2025

(30) Foreign Application Priority Data
Mar. 20, 2023 (EP) 23162795.1

(51) Int. Cl. C08L 25/14; C08K 11/00

(52) U.S. Cl. CPC C08L 25/14; C08K 11/00; C08K 2201/005; C08L 2207/04

(57) ABSTRACT

The invention relates to a thermoplastic molding composition comprising at least one vinylaromatic (co)polymer and at least one filler comprising spent coffee grounds. The molding composition according to the invention is characterized by having a reduced coefficient of friction while its surface energy is only moderately changed. The invention also relates to a process for reducing the coefficient of friction of a thermoplastic molding composition by adding spent coffee grounds. Moreover, the invention relates to the use of spent coffee grounds as friction modifier for thermoplastic polymer compositions.

The present invention relates to a thermoplastic molding composition comprising at least one vinylaromatic (co)polymer and at least one filler comprising spent coffee grounds. The molding composition according to the invention is characterized by having a reduced coefficient of friction while its surface energy is only moderately changed. The invention also relates to a process for reducing the coefficient of friction of a thermoplastic molding composition by adding spent coffee grounds. Moreover, the invention relates to the use of spent coffee grounds as friction modifier for thermoplastic polymer compositions.

Vinylaromatic homo- and copolymers, such as polystyrene (PS), poly(styrene-acrylonitrile) (SAN), poly(alpha-methyl styrene-acrylonitrile) (AMSAN) and poly(styrene-methyl methacrylate) (SMMA) as well as blends of vinylaromatic copolymers with other polymers (e.g. impact-modifying polymers) are well known and widely used in industry and science due to their versatile and tailorable property profile. Vinylaromatic homo- and copolymers offer a good balance of properties and are attractive for a lot of applications. In order to enhance specific properties, e.g. impact strength, and/or to reduce the total amount of polymer constituent in a molding composition, often fillers are added to the thermoplastic polymers.

With about 2.5 billion cups of coffee consumed worldwide every day, coffee is one of the most frequently consumed beverage. The extraction of ground coffee beans for the preparation of fresh coffee as well as for the industrial production of instant coffee creates about 18 million tons of spent coffee grounds every year. Typically, those spent coffee grounds are sent to landfill or anaerobic digestion. However, attempts were made to use spent coffee ground as additives in polymer compositions.

GB 1,207,801 describes synthetic such as thermosets or thermoplastic resins with fillers made from coffee grounds that have been fully or partially de-oiled and finely ground.

U.S. Pat. No. 4,101,050 teaches laminates with one layer of impact-modified polystyrene comprising at least one filler. The filler may be a naturally derived product, including waste products. Waste coffee grounds are not mentioned.

US 2022/0227980 discloses polyolefin-based resin compositions comprising heat-treated waste coffee grounds. The waste coffee grounds are heated to 500 to 800° C. to reduce the volatile matter from 36 wt.-% after extraction to less than 20 wt.-% after heat treatment.

KR 2022-0055321 teaches the use of waste coffee ground as flame retardant filler in polymer composite materials, preferably on the basis of epoxy resins.

There is an increasing demand in industry for polymer compositions with sustainable constituents. However, at the same time, the overall properties of the polymer compositions should desirably change only moderately. Moreover, adding spent coffee grounds to brittle resins results in low impact strength. However, an increased amount of impact modifying polymers would typically result in a soft product. The present inventors found that a balanced ratio of spent coffee grounds and impact modifying polymers may result in a polymer composition with a good property profile. This is advantageous in such household applications where recycled waste content would be appealing but impact and surface energy needs to be maintained.

It has been surprisingly found by the inventors, that thermoplastic molding composition comprising at least one vinylaromatic (co)polymer may be admixed with filler components comprising spent coffee grounds and exhibit improved properties with respect to friction and water uptake.

In one aspect, the present invention is concerned with a thermoplastic molding composition P comprising (or consisting of):
A: 80 to 99.9 wt.-%, preferably 82 to 99.8 wt.-%, more preferably 85 to 99.7 wt.-%, based on the thermoplastic molding composition P, of at least one vinylaromatic (co)polymer composition as component A;
B: 0.1 to 20 wt.-%, preferably 0.2 to 18 wt.-%, more preferably 0.3 to 15 wt.-%, based on the thermoplastic molding composition P, of at least one filler comprising spent coffee grounds as component B; and
C: 0 to 10 wt.-%, based on the thermoplastic molding composition P, of at least one further additive as component C, wherein the at least one further additive of component C is different from component B;
wherein components A, B, and C sum up to 100 wt.-% of the thermoplastic molding composition P.

It has been surprisingly found that the addition of 0.1 to 20 wt.-% of fillers comprising spend coffee grounds reduce the coefficient of friction of a vinylaromatic (co)polymer composition. If the amount of spent coffee grounds is below 0.1 wt.-%, the effect on the coefficient of friction is too low. If, however, the amount of spent coffee grounds exceed 20 wt.-%, mechanical stability of the resulting composition is negatively affected.

At the same time, the surface energy of the vinylaromatic (co)polymer composition is reduced only moderately. Moreover, the water uptake of the vinylaromatic (co)polymer composition is increased.

These effects of the spent coffee grounds are highly surprising since a decrease in coefficient of friction is usually accompanied by a loss in surface energy. Common friction modifiers, such as waxes or silicone fillers, typically decrease the coefficient of friction but also decrease the surface energy of the polymer composition, which often results in problems with regard to printability and wettability. This effect was not observed for the thermoplastic molding compositions according to the present invention comprising spent coffee grounds. It is believed that the hydroscopic nature of the coffee grounds leads to an increase water absorption which also allows to maintain good surface energy for the material. This is an advantage over using common friction modifiers, such as waxes or silicone fillers, which normally significantly decrease the surface energy of a material while decreasing the coefficient of friction.

Preferably, the thermoplastic molding composition P according to the invention comprises 0.2 to 18 wt.-%, often 0.3 to 15 wt.-%, for example 0.5 to 13 wt.-%, based on the thermoplastic molding composition P, of at least one filler comprising spent coffee grounds as component B. Filler components B comprising spent coffee grounds according to the invention are described in further detail herein below.

The thermoplastic molding composition P according to the invention my further comprise up to 10 wt.-%, based on the thermoplastic molding composition P, of at least one further additive component C which is different from the filler component B (and component A). Typically, the thermoplastic molding composition P comprises 0.01 to 10 wt.-%, often 0.05 to 8 wt.-%, for example 0.1 to 5 wt.-%, based on the thermoplastic molding composition P, of at least one further additive as component C. Typically, additive(s) are added in order to improve the properties of the thermoplastic molding composition P with regards to stability towards light, heat and oxidation, and/or to improve its processability. Suitable additive components C are further described herein below.

Accordingly, one aspect of the invention relates to a thermoplastic molding composition P comprising (or consisting of):
A: 80 to 99.89 wt.-%, preferably 82 to 99.75 wt.-%, more preferably 85 to 99.6 wt.-%, based on the thermoplastic molding composition P, of at least one vinylaromatic (co)polymer composition as component A;
B: 0.1 to 19.99 wt.-%, preferably 0.2 to 17.95 wt.-%, more preferably 0.3 to 14.9 wt.-%, based on the thermoplastic molding composition P, of at least one filler comprising spent coffee grounds as component B; and
C: 0.01 to 10 wt.-%, often 0.05 to 8 wt.-%, for example 0.1 to 5 wt.-%, based on the thermoplastic molding composition P, of at least one further additive as component C, wherein the at least one further additive of component C is different from component B;
wherein components A, B, and C sum up to 100 wt.-% of the thermoplastic molding composition P.

The obtained thermoplastic molding composition P can be easily processed, i.e. molded to any desired shape e.g. by extrusion and/or hot molding (e.g. injection molding) and can be processed to a shaped article. The shaped article may be advantageously used in numerous applications, such as for the production household goods.

In a further aspect, the invention relates to a process for reducing the coefficient of friction of a thermoplastic vinylaromatic (co)polymer composition, using at least one filler comprising spent coffee grounds as component B.

In yet another aspect, the invention relates to the use of spent coffee grounds as friction modifier for thermoplastic vinylaromatic (co)polymer compositions.

The invention also relates to a process for producing a thermoplastic molding composition P.

The components A, B, and C, according to the invention, as well as the processes and applications of the invention are described in further detail in the following.

### Component A

According to the invention, the thermoplastic molding composition P comprises 80 to 99.9 wt.-%, based on the thermoplastic molding composition P, of at least one vinylaromatic (co)polymer (composition) as component A.

Preferably, the at least one vinylaromatic (co)polymer component A comprises (or consists of):
A1: at least one thermoplastic vinylaromatic polymer and/or at least one thermoplastic vinylaromatic copolymer; and

A2: optionally at least one impact modifying polymer and/or at least one impact modifying copolymer comprising at least repeating units of monomers selected from diene monomers, acrylate monomers and mixtures thereof and optionally repeating units of vinyl aromatic monomers.

The at least one thermoplastic vinylaromatic polymer and/or at least one thermoplastic vinylaromatic copolymer is preferably selected from homopolymers of vinylaromatic monomers, copolymers of vinylaromatic monomers with acrylonitrile, methacrylonitrile and/or acrylate monomers, and mixtures thereof.

The at least one impact modifying polymer and/or at least one impact modifying copolymer comprises at least repeating units of monomers selected from diene monomers, acrylate monomers and mixtures thereof and optionally repeating units of vinyl aromatic monomers.

Suitable vinylaromatic monomers include styrene, C₁-C₄-alkyl styrene, divinyl benzene, preferably styrene and alpha-methylstyrene. Suitable acrylate monomers include C₁-C₈-alkyl (meth)acrylate and alkylene glycol di(meth)acrylate, preferably methyl methacrylate and butyl acrylate. Suitable diene monomers include butadiene and isoprene, preferably butadiene.

The vinylaromatic (co)polymer component A may also comprise further monomers, for example anhydrides of unsaturated carboxylic acids and imides of unsaturated carboxylic acids or cross-linking agents.

Preferably, the at least one vinylaromatic (co)polymer component A comprises at least one impact-modifying copolymer A2.

In one embodiment, the at least one vinylaromatic (co)polymer component A comprises (or consists of):
A1: at least one thermoplastic vinylaromatic polymer and/or at least one thermoplastic vinylaromatic copolymer selected from homopolymers of vinylaromatic monomers, copolymers of vinylaromatic monomers with acrylonitrile, methacrylonitrile and/or acrylate monomers, and mixtures thereof; and
A2: at least one impact modifying polymer and/or at least one impact modifying copolymer comprising at least repeating units of monomers selected from diene monomers, acrylate monomers and mixtures thereof and optionally repeating units of vinyl aromatic monomers.

Preferably, the at least one vinylaromatic (co)polymer component A comprises (or consists of):
A1:20 to 90 wt.-%, preferably 30 to 80 wt.-%, more preferably 40 to 75 wt.-% often 50 to 70 wt.-%, for example 58 to 65 wt.-% or 50 to 57 wt.-%, based on the total weight of component A, of at least one thermoplastic vinylaromatic polymer and/or at least one thermoplastic vinylaromatic copolymer; and
A2:10 to 80 wt.-%, preferably 20 to 70 wt.-%, more preferably 25 to 60 wt.-%, often 30 to 50 wt.-%, for example 35 to 42 wt.-% or 43 to 50 wt.-%, based on the total weight of component A, at least one impact modifying polymer and/or at least one impact modifying copolymer;
wherein components A1 and A2 sum up to 100 wt.-% of component A.

In one embodiment of the invention, the at least one vinylaromatic (co)polymer component A comprises (of consists of):
A1: at least one thermoplastic vinylaromatic copolymer comprising repeating units of styrene and methyl methacrylate; and
A2: at least one impact modifying copolymer comprising repeating units of styrene and butadiene.

Examples of suitable vinylaromatic (co)polymer components A1 include poly(styrene) (e.g. general purpose polystyrene, GPPS), poly(styrene-methyl methacrylate) (SMMA), poly(styrene-acrylonitrile) (SAN), poly(alpha-methyl styrene-acrylonitrile) (AMSAN), poly(butadiene).

Examples of suitable impact modifying copolymers A2 include graft copolymers of acrylonitrile, butadiene and styrene (ABS), graft copolymers of acrylonitrile, butylacrylate and styrene (ASA), block copolymers of styrene and butadiene (SBC), hydrogenated block copolymers of styrene and butadiene (SEBS) and mixtures thereof.

Preferred examples of the at least one vinylaromatic (co)polymer component A include polymer blends of PS and SBC (i.e. high impact polystyrene (HIPS)), polymer blends of SAN and ABS, polymer blends of SAN and ASA, polymer blends of SMMA and SBC, polymer blends of SMMA and SEBS. In one embodiment, the at least one vinylaromatic (co)polymer component A is a polymer blend of SMMA and SBC.

From sustainability aspects, the at least one vinylaromatic (co)polymer component A can advantageously comprise or consist of a post-industrial or post-consumer recycled at least one vinylaromatic (co)polymer component.

### Component B

According to the invention, the thermoplastic molding composition P comprises 0.1 to 20 wt.-%, based on the thermoplastic molding composition P, of at least one filler comprising spent coffee grounds as component B.

In general, all spent coffee grounds can be use in accordance with the invention. Spent coffee grounds are typically produced as a waste product in industry (e.g. in the production of instant coffee) or in households. Typically, the spent coffee grounds contain residual moisture from the extraction process for producing coffee.

Preferably, component B comprises (or consists of) at least 80 wt.-%, preferably at least 85 wt.-%, based on the total weight of component B, of spent coffee grounds and up to 20 wt.-%, preferably less than 15 wt.-%, based on the total weight of component B, of residual moisture. In order to achieve these composition requirements, the spent coffee grounds can be dried, if necessary. Preferably, the moisture content in component B is within the range of from 1 to 15 wt.-%, often from 3 to 13 wt.-%, for example 7 to 13 wt.-% or 1 to 6 wt.-%, based on the total weight of component B.

The residual moisture content indicates the proportion of residual moisture, in particular water, in percent by weight, based on component B. In particular, the moisture content is determined using suitable analytical equipment (e.g. drying scales), whereby the sample is dried until a constant weight of the sample is achieved over a certain period of time. For example, the moisture content of component B can be determined in a Halogen Moisture Analyzer HR73 from Mettler-Toledo at 180° C. until a constant weight is achieved for 30 seconds.

Preferably, the spent coffee grounds have a weight average particle size D50 of ≤220 μm, preferably ≤210 μm.

Preferably, the spent coffee grounds have a volume average particle size D50 of ≤220 μm, preferably ≤210 μm. Volume average particle size is determined, for example, by laser diffraction according to ISO13320 (2020).

### Component C

According to the invention, the thermoplastic molding composition P may comprise up to 10 wt.-%, preferably up to 5 wt.-%, based on the thermoplastic molding composition P, of at least one further additive as component C, wherein the at least one further additive of component C is different from component B. Preferably, the thermoplastic molding composition P may comprise from 0.05 to 8 wt.-%, for example 0.1 to 5 wt.-%, based on the thermoplastic molding composition P, of one or more additive(s) C.

The additives C may be admixed with the at least one vinylaromatic (co)polymer composition as component A and the at least one filler comprising spent coffee grounds as component B during the preparation of the polystyrene composition P.

The additional additive C is typically selected from commonly known additives for polystyrenes and copolymers and compositions thereof. Substances that can be used as additives or auxiliaries are the polymer additives known to the person skilled in the art and described in the prior art (e.g. Plastics Additives Handbook, ed. Schiller et al., 6th Ed, 2009, Hanser). The additive and/or auxiliary can be added either before or during the compounding procedure (mixing of the polymeric components A and B in the melt).

The thermoplastic molding composition P may comprise, as component C, from 0.01 to 5 wt.-% of usual additives, such as processing aids, stabilizers, oxidation inhibitors, ultraviolet light absorbers, lubricants, flame retardants, colorants, pigments, and plasticizers.

Examples of oxidation inhibitors and heat stabilizers are sterically hindered phenols, various substituted representatives of these groups and mixtures thereof in concentrations of up to 1 wt.-%, based on the thermoplastic molding composition P.

UV stabilizers, which may be mentioned, and are generally used in amounts of up to 2 wt.-%, based on the thermoplastic molding composition P, are various substituted resorcinols, salicylates, benzotriazoles and benzophenones different from component B. Furthermore, secondary stabilizers such as Irgafos® 168 (BASF) may be used. Said secondary stabilizers are commercially available.

The afore-mentioned stabilizers are preferably used in amounts of 0.01 to 0.5 wt.-%, more preferably 0.1 to 0.3 wt.-%, based on the thermoplastic molding composition P.

An example of a processing aid, which can be used in amounts from 0.1 to 5 wt.-%, preferably from 0.5 to 4 wt.-%, based on the thermoplastic molding composition P, is a homogeneously miscible oil or oil mixture, in particular selected from mineral oils (medical grade mineral oil), vegetable oils (also referred to as plant oils) and silicon oils. In particular, medical grade mineral oil (e.g. DAB 70) may be used as additive C in amounts of 1 to 4 wt.-%, based on the thermoplastic molding composition P.

Preferred lubricants may be selected from long-chain fatty acids, such as stearic acid or behenic acid, salts of fatty acids (e.g. calcium stearate or zinc stearate), esters of fatty acids (e.g. stearyl stearate or pentaerythrityl tetrastearate), amide derivatives of fatty acids (e.g. ethylenebisstearylamide, erucamide, Acrawax®), phosphates (such as tricalcium phosphate), hydrocarbon waxes, such as microcrystalline waxes and paraffin waxes (e.g. Besquare®), and fumed silica (e.g. Aerosil®). Typically, fatty acids are carboxylic acids having a linear or branched, saturated or unsaturated C₅-C₂₅ alkyl chain.

Process for producing the thermoplastic molding composition P

A further aspect of the invention relates to a process for producing a thermoplastic molding composition P comprising at least the following process steps:
(i) providing components A, B and optionally C; and
(ii) compounding the components A, B, and optionally C by melt-mixing, preferably in an extruder.

Components A, B, and C are generally commercially available.

Preferably, at least one vinylaromatic (co)polymer composition A is provided in a molten state and the filler component B as well as the optional additive(s) C are added to a melt of the vinylaromatic (co)polymer composition A. The mixing of the components can be performed by suitable means such as e.g. a mixer, a kneader or an extruder, preferably a twin screw extruder. The melt-mixing may be performed, preferably in an extruder, at temperatures in the range of from 160 to 260° C. Preferably, melt-mixing is performed in an extruder at temperatures in the range of from 180 to 230° C. In one embodiment, the melt-mixing may be performed in an extruder including at least one degassing opening from which residual moisture, e.g. moisture absorbed in the filler component B, is removed, for example by means of a vacuum applied to the degassing opening. Often the applied vacuum is at least 200 mbar below atmospheric pressure, more preferably at least 300 mbar below atmospheric pressure.

The filler component B and the optional additive(s) C can be added to the vinylaromatic (co)polymer composition A in one process step or in separate process steps. The filler component B and the optional additive(s) C may be mixed separately prior to the addition to the vinylaromatic (co)polymer composition A. Preferably, the filler component B and the optional additive(s) C are added to the melt of the vinylaromatic (co)polymer composition A simultaneously, but in separate feeds.

Method for reducing the coefficient of friction of a thermoplastic vinylaromatic (co) polymer composition

In a further aspect, the invention relates to a method for reducing the coefficient of friction of a thermoplastic vinylaromatic (co)polymer composition, wherein the method includes the step of compounding the at least one thermoplastic vinylaromatic (co)polymer composition with spent coffee grounds. As outlined herein, the addition of spent coffee grounds to thermoplastic vinylaromatic (co)polymer compositions efficiently reduces the coefficient of friction of the thermoplastic vinylaromatic (co)polymer composition. At the same time, the surface energy of the vinylaromatic (co)polymer composition is reduced only moderately. Moreover, the water uptake of the vinylaromatic (co)polymer composition is increased.

Preferably, the thermoplastic vinylaromatic (co)polymer composition and the spent coffee grounds are as defined for components A and B.

In one embodiment according to the method for reducing the coefficient of friction according to the invention, the coefficient of friction of the thermoplastic vinylaromatic (co)polymer composition is reduced by the addition of spent coffee grounds whereas the surface energy of the thermoplastic vinylaromatic (co)polymer composition is decreased by less than 15%, preferably less than 10%.

According to a further embodiment of the method for reducing the coefficient of friction according to the invention, the coefficient of friction of the thermoplastic vinylaromatic (co)polymer composition is reduced by the addition of spent coffee grounds whereas the water uptake of the thermoplastic vinylaromatic (co)polymer composition is increased.

In general, the coefficient of friction is determined according to ASTM D1894 using a glass substrate. Water uptake is measured according to ASTM D570. Surface energy is determined via the water contact angle. The water contact angle is measured and wetting tension/surface energy was calculated via the contact angle according to ASTM D5946.

Use of spent coffee grounds as friction modifier thermoplastic vinylaromatic (co)polymer compositions.

In a further aspect, the invention relates to the use of spent coffee grounds as friction modifier for thermoplastic vinylaromatic (co)polymer compositions. As outlined herein, the addition of spent coffee grounds to thermoplastic vinylaromatic (co)polymer compositions efficiently reduces the coefficient of friction of the thermoplastic vinylaromatic (co)polymer composition compared to the one thermoplastic vinylaromatic (co)polymer composition. At the same time, the surface energy of the vinylaromatic (co)polymer composition is reduced only moderately. Moreover, the water uptake of the vinylaromatic (co)polymer composition is increased.

Accordingly, the invention preferably relates to the use of spent coffee grounds as friction modifier for thermoplastic vinylaromatic (co)polymer compositions, wherein the coefficient of friction of the thermoplastic vinylaromatic (co)polymer composition is reduced upon addition of spent coffee grounds.

According to one embodiment of the use of spent coffee grounds as friction modifier for thermoplastic vinylaromatic (co)polymer according to the invention, the surface energy of the thermoplastic vinylaromatic (co)polymer composition is decreased by less than 15%, preferably less than 10%, upon addition of spent coffee grounds.

According to one embodiment of the use of spent coffee grounds as friction modifier for thermoplastic vinylaromatic (co)polymer according to the invention, the water uptake of the thermoplastic vinylaromatic (co)polymer composition is increased upon addition of spent coffee grounds.

The invention also relates to spent coffee grounds as described herein as and when used as friction modifier for thermoplastic vinylaromatic (co)polymer compositions.

The invention also relates to thermoplastic vinylaromatic (co)polymer compositions using spent coffee grounds as friction modifier as described herein.

The invention is illustrated by the following examples and claims.

### EXAMPLES

Examples and comparative examples are prepared using the following materials and characterized by the following methods.

### Materials

A1 post-industrial recycled copolymer of styrene and methyl methacrylate (SMMA) having a content of methyl methacrylate ranging from 1 to 50 wt.-%. The component A1 further comprises oil as processing aid in amounts of 0 to 4 wt.-%.
A2: Copolymer of styrene and butadiene (SBC) having a weight ratio of styrene to butadiene of 75:25.
B Waste coffee grounds with a moisture content of less than 5 wt.-%+1 wt.-% having a volume average particle size D50 of ≤220 μm.

### Methods

Volume average particle size is determined by laser diffraction according to ISO13320 (2020).

Melt flow rate (MFR) was determined according to ASTM D1238 at 200° C. and 5 kg.

Notched Izod impact strength is determined on injection-molded sample plaques according to ASTM D256.

Tensile stress at break and tensile strain at break are determined according to ASTM D638.

The coefficient of friction is determined according to ASTM D1894 using a glass substrate.

CIE color space values measured using a D65 light source (observation angle) 10° according to ASTM E1331. Gloss included in color measurements.

Water uptake is measured according to ASTM D570.

The water contact angle is measured (though the surface was not corona treated) and wetting tension/surface energy was calculated via the contact angle according to ASTM D5946.

### Preparation

The components A1, A2 and B are compounded in the ratios given in Tables 1 and 2 in a twin-screw extruder at 200° C. to obtain thermoplastic molding compositions according to the invention. Sample plaques are obtained by injection molding of the obtained themoplastic molding compositions. The sample plaques are characterized by the methods described above.

TABLE 1
Formulations and properties of Comparative Example 1 and Examples 2 to 6.

| | | Comp. | | | | | |
|---|---|---|---|---|---|---|---|
| | Units | Ex. 1 | Ex. 2 | Ex. 3 | Ex. 4 | Ex. 5 | Ex. 6 |
| A1: SMMA | wt.-% | 60 | 58 | 56 | 50 | 48 | 46 |
| A2: SBC | wt.-% | 40 | 40 | 40 | 44 | 44 | 44 |
| B | wt.-% | 0 | 2 | 4 | 6 | 8 | 10 |
| MFR (200° C., 5 kg) | g/10 min | 4.1 | 4.2 | 4.2 | 4.5 | 4.7 | 5.8 |
| notched Izod impact | J/m | 27 | 64 | 53 | 64 | 64 | 80 |
| strength | (ft-lb/in) | (0.5) | (1.2) | (1.0) | (1.2) | (1.2) | (1.5) |
| tensile stress at | MPa | 26.1 | 25.2 | 23.6 | 21.5 | 20.8 | 19.4 |
| break | (psi) | (3792) | (3660) | (3416) | (3122) | (3011) | (2816) |
| tensile strain at break | % | 48 | 32 | 22 | 26 | 26 | 22 |
| L* | | 92.7 | 34.1 | 26.8 | 27.0 | 28.3 | 29.7 |
| a* | | 0.4 | 11.4 | 1.1 | 0.1 | 0.0 | 0.0 |
| b* | | 4.8 | 10.7 | −0.6 | −0.9 | −0.8 | −0.7 |
| water uptake | % | 0.12 | 0.18 | 0.24 | 0.27 | 0.27 | 0.36 |
| water contact angle | ° | 99 | 104 | 104 | 104 | 104 | 102 |
| surface energy | mJ/m² | 50 | 48 | 48 | 48 | 48 | 49 |
| | (dyn/cm) | (50) | (48) | (48) | (48) | (48) | (49) |
| coefficient of friction | static | 0.180 | 0.161 | 0.147 | 0.137 | 0.137 | 0.158 |

TABLE 2
Formulations and properties of Comparative Example 7 and Examples 8 to 12.

| | | Comp. | | | | | |
|---|---|---|---|---|---|---|---|
| | Units | Ex. 7 | Ex. 8 | Ex. 9 | Ex. 10 | Ex. 11 | Ex. 12 |
| A1: SMMA | wt.-% | 52 | 50 | 48 | 46 | 44 | 42 |
| A2: SBC | wt.-% | 48 | 48 | 48 | 48 | 48 | 48 |
| B | wt.-% | 0 | 2 | 4 | 6 | 8 | 10 |
| MFR (200° C., 5 kg) | g/10 min | 4.5 | 4.7 | 4.4 | 4.8 | 4.9 | 5.4 |
| notched Izod impact | J/m | 214 | 144 | 133 | 128 | 112 | 101 |
| strength | (ft-lb/in) | (4.0) | (2.7) | (2.5) | (2.4) | (2.1) | (1.9) |
| tensile stress at | MPa | 23.9 | 22.1 | 21.6 | 21.6 | 19.8 | 19.2 |
| break | (psi) | (3464) | (3204) | (3140) | (3128) | (2870) | (2785) |
| tensile strain at break | % | 75 | 57 | 50 | 42 | 39 | 35 |
| L* | | 93.6 | 29.5 | 27.0 | 26.9 | 28.2 | 28.9 |
| a* | | 0.2 | 6.6 | 1.4 | 0.4 | 0.1 | 0.0 |
| b* | | 3.7 | 3.6 | −0.4 | −0.7 | −0.8 | −0.8 |
| water uptake | % | 0.12 | 0.20 | 0.21 | 0.26 | 0.34 | 0.38 |
| water contact angle | ° | 103 | 105 | 105 | 105 | 105 | 104 |
| surface energy | mJ/m² | 48 | 48 | 48 | 48 | 48 | 48 |
| | (dyn/cm) | (48) | (48) | (48) | (48) | (48) | (48) |
| coefficient of friction | static | 0.235 | 0.136 | 0.146 | n/a | 0.156 | n/a |

The examples and comparative examples summarized in Tables 1 and 2 demonstrate that the addition of spent coffee grounds to a polymer blend of SMMA and SBC significantly reduce the coefficient of friction of the polymer blend.

At the same time, the water uptake increases while the surface energy changes one moderately. For blends with an SBC content of more than 45 wt.-%, the surface energy even remains unchanged within the examined compositional range.

Further examples are prepared using as component A general purpose polystyrene (GPPS), SMMA, ABS, or high impact polystyrene (HIPS) leading to good results.

Further examples are prepared using as component A a polymer blend of GPPS and SBC as vinylaromatic (co)polymer composition leading to good results.

1-15. (canceled)

16. A thermoplastic molding composition P comprising:
A: 80 to 99.9 wt.-%, based on the thermoplastic molding composition P, of at least one vinylaromatic (co)polymer composition as component A;
B: 0.1 to 20 wt.-%, based on the thermoplastic molding composition P, of at least one filler comprising spent coffee grounds as component B, wherein component B comprises at least 80 wt.-%, based on the total weight of component B, of spent coffee grounds and up to 20 wt.-%, based on the total weight of component B, of residual moisture; and
C: 0 to 10 wt.-%, based on the thermoplastic molding composition P, of at least one further additive as component C, wherein the at least one further additive of component C is different from component B;
wherein components A, B, and C sum up to 100 wt.-% of the thermoplastic molding composition P,
wherein the at least one vinylaromatic (co)polymer component A comprises:
A1: at least one thermoplastic vinylaromatic polymer and/or at least one thermoplastic vinylaromatic copolymer selected from homopolymers of vinylaromatic monomers, copolymers of vinylaromatic monomers with acrylonitrile and/or acrylate monomers, and mixtures thereof; and
A2: optionally at least one impact modifying polymer and/or at least one impact modifying copolymer.

17. The thermoplastic molding composition P according to claim 16, wherein component B comprises at least 85 wt.-%, based on the total weight of component B, of spent coffee grounds and less than 15 wt.-%, based on the total weight of component B, of residual moisture.

18. The thermoplastic molding composition P according to claim 16, wherein the spent coffee grounds have a weight average particle size D50 of ≤220 μm.

19. The thermoplastic molding composition P according to claim 16,
wherein the at least one vinylaromatic (co)polymer component A comprises:
A1:20 to 90 wt.-%, based on the total weight of component A, of at least one thermoplastic vinylaromatic polymer and/or at least one thermoplastic vinylaromatic copolymer; and
A2:10 to 80 wt.-%, based on the total weight of component A, at least one impact modifying polymer and/or at least one impact modifying copolymer;
wherein components A1 and A2 sum up to 100 wt.-% of component A.

20. The thermoplastic molding composition P according to claim 16,
wherein the at least one vinylaromatic (co)polymer component A comprises:
A1: at least one thermoplastic vinylaromatic copolymer comprising repeating units of styrene and methyl methacrylate; and
A2: at least one impact modifying copolymer comprising repeating units of styrene and butadiene.

21. A process for producing a thermoplastic molding composition P according to claim 16 comprising at least the following process steps:
(i) providing components A, B and optionally C; and
(ii) compounding the components A, B, and optionally C by melt-mixing.

22. A method for reducing the coefficient of friction of a thermoplastic vinylaromatic (co)polymer composition wherein the method includes the step of compounding the at least one thermoplastic vinylaromatic (co)polymer composition with spent coffee grounds, wherein the at least one thermoplastic vinylaromatic (co)polymer composition comprises:
A1: at least one thermoplastic vinylaromatic polymer and/or at least one thermoplastic vinylaromatic copolymer selected from homopolymers of vinylaromatic monomers, copolymers of vinylaromatic monomers with acrylonitrile and/or acrylate monomers, and mixtures thereof; and
A2: at least one impact modifying polymer and/or at least one impact modifying copolymer comprising at least repeating units of monomers selected from diene monomers, acrylate monomers and mixtures thereof and optionally repeating units of vinyl aromatic monomers.

23. The method according to claim 22, wherein the coefficient of friction of the thermoplastic vinylaromatic (co)polymer composition is decreased whereas the surface energy of the thermoplastic vinylaromatic (co)polymer composition is decreased by less than 15%.

24. The method according to claim 22, wherein the coefficient of friction of the thermoplastic vinylaromatic (co)polymer composition is decreased whereas the water uptake of the thermoplastic vinylaromatic (co)polymer composition is increased.

25. A method of using spent coffee grounds as a friction modifier for thermoplastic vinylaromatic (co)polymer compositions.

26. The method according to claim 25, wherein the coefficient of friction of the thermoplastic vinylaromatic (co)polymer composition is decreased upon addition of spent coffee grounds.

27. The method according to claim 25, wherein the surface energy of the thermoplastic vinylaromatic (co)polymer composition is decreased by less than 15%, upon addition of spent coffee grounds.

28. The method according to claim 25, wherein the water uptake of the thermoplastic vinylaromatic (co)polymer composition is increased upon addition of spent coffee grounds.

29. The process according to claim 21, wherein the components A, B, and optionally Care compounded in process step (ii) in an extruder.

30. The method according to claim 22, wherein the coefficient of friction of the thermoplastic vinylaromatic (co)polymer composition is decreased whereas the surface energy of the thermoplastic vinylaromatic (co)polymer composition is decreased by less than 10%.

31. The method according to claim 25, wherein the surface energy of the thermoplastic vinylaromatic (co)polymer composition is decreased by less than 10%, upon addition of spent coffee grounds.
